(19) United States
(12) Patent Application Publication
(10) Pub. No.: US 2024/0371129 A1
(43) Pub. Date: Nov. 7, 2024

(54) LEARNING SYSTEM, LEARNING METHOD, AND PROGRAM

(71) Applicant: RAKUTEN GROUP, INC., Tokyo (JP)

(72) Inventors: Yeongnam CHAE, Setagaya-ku, Tokyo (JP); Preetham PRAKASHA, Setagaya-ku, Tokyo (JP); Mijung KIM, Setagaya-ku, Tokyo (JP); Poulami RAHA, Setagaya-ku, Tokyo (JP); Bjorn STENGER, Setagaya-ku, Tokyo (JP)

(21) Appl. No.: 18/686,882

(22) PCT Filed: Mar. 24, 2022
(86) PCT No.: PCT/JP2022/014019

§ 371 Date: Feb. 27, 2024

(51) Int. Cl. G06V 10/74

(52) U.S. Cl. CPC G06V 10/761

(57) ABSTRACT

A learning system, comprising at least one processor configured to: acquire a first training image relating to a first object having a first numerical value; acquire a second training image relating to a second object having a second numerical value; and execute learning processing of a learning model which estimates a numerical value to be estimated relating to an object to be estimated included in an estimation-target image, based on metric learning using the first training image and the second training image.

### TECHNICAL FIELD

The present disclosure relates to a learning system, a learning method, and a program.

### BACKGROUND ART

Hitherto, there has been known a learning model for estimating a numerical value relating to an object included in an image. For example, in Non Patent Literature 1, there is described a technology for cutting out a portion showing a body part, for example, eyes or a nose, from a photograph of a human face, which is an example of an object, and inputting the cut-out portion to a learning model for estimating age. This learning model outputs a probability distribution indicating a probability of each age. Age is estimated by summing values obtained by multiplying each probability by the age indicated in the probability distribution.

For example, in Non Patent Literature 2, there is described a technology using, as a learning method of a learning model which outputs a score for each age when a face photograph is input, a softmax loss relating to a softmax function, a mean loss relating to a deviation between an average age corresponding to an output of the learning model and the ground-truth age, and a variance loss relating to a variance of the age corresponding to the output of the learning model. For example, in Non Patent Literature 3, there is described a technology for estimating age by identifying a plurality of regions from a face photograph and inputting each region to a learning model.

### CITATION LIST

### Non Patent Literature

[NPL 1] Rasmus Rothe, Radu Timofte, Luc Van Gool, “Deep Expectation of apparent age from a single image,” ICCVW2015, https://openaccess.thecvf.com/content_iccv_2015_workshops/w11/papers/Rothe_DEX_Deep_Expectation_ICCV_2015_paper.pdf
[NPL 2] Hongyu Pan, Hu Han, Shiguang Shan, Xilin Chen, “Mean-Variance Loss for Deep Age Estimation from a Face,” CVPR2018, https://openaccess.thecvf.com/content_cvpr_2018/papers/Pan_Mean-Variance_Loss_for_CVPR_2018_paper.pdf
[NPL 3] Chao Zhang, Shuaicheng Liu, Xun Xu, Ce Zhu, “Exploring the Limits of Compact Model for Age Estimation,” CVPR2019, https://openaccess.thecvf.com/content_CVPR_2019/papers/Zhang_C3AE_Exploring_the_Limits_of_Compact_Model_for_Age_Estimation_CVPR_2019_paper.pdf

### SUMMARY OF INVENTION

### Technical Problem

However, in the technologies of Non Patent Literature 1 to Non Patent Literature 3, in order to improve the accuracy of the learning model, it is required to prepare a large number of training images, which is very time-consuming. This point is not limited to learning models which estimate the age of an object, but also applies to learning models which estimate a numerical value other than age (for example, height or weight). For this reason, there is a demand to improve the accuracy of learning models which estimate the numerical value of an object included in an image even with a small amount of training images.

One object of the present disclosure is to improve an accuracy of a learning model which estimates a numerical value relating to an object included in an image.

### Solution to Problem

According to one embodiment of the present disclosure, there is provided a learning system including: acquisition module configured to acquire a first training image relating to a first object having a first numerical value; a second acquisition module configured to acquire a second training image relating to a second object having a second numerical value; and a learning module configured to execute a first learning processing of a learning model which estimates a numerical value to be estimated relating to an object to be estimated included in an estimation-target image, based on metric learning using the first training image and the second training image.

### Advantageous Effects of Invention

According to the present disclosure, the accuracy of the learning model which estimates the numerical value relating to the object included in the image is improved.

### BRIEF DESCRIPTION OF DRAWINGS

FIG. 1 is a diagram for illustrating an example of an overall configuration of a learning system.

FIG. 2 is a diagram for illustrating an example of how a trained learning model is used.

FIG. 3 is a diagram for illustrating an example of learning processing of a learning model.

FIG. 4 is a functional block diagram for illustrating an example of functions implemented in the learning system.

FIG. 5 is a table for showing an example of a training database.

FIG. 6 is a diagram for illustrating an example of a method in which a cosine similarity loss is used.

FIG. 7 is a diagram for illustrating an example of a method in which a triplet margin loss is used.

FIG. 8 is a flow chart for illustrating an example of processing to be executed by the learning system.

FIG. 9 is a diagram for illustrating an example of a triplet margin loss in Modification Example 2 of the present disclosure.

### DESCRIPTION OF EMBODIMENTS

### 1. Overall Configuration of Learning System

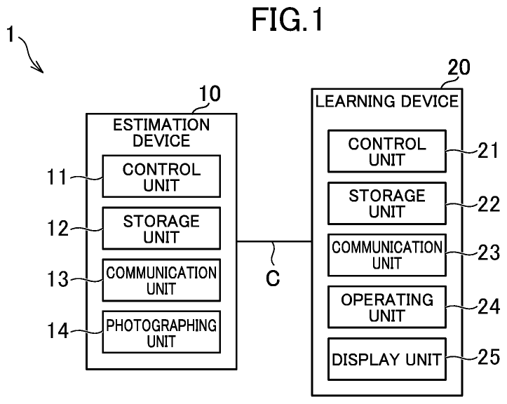

Description is now given of an example of an embodiment of a learning system according to the present disclosure. FIG. 1 is a diagram for illustrating an example of an overall configuration of the learning system. For example, a learning system 1 includes an estimation device 10 and a learning device 20. In this embodiment, there is described a case in which the estimation device 10 and the learning device 20 are communicably connected by a communication cable C, but the estimation device 10 and the learning device 20 may be communicably connected by a network, such as the Internet or a LAN. It suffices for the learning system 1 to include at least one computer, and the learning system 1 is not limited to the example of FIG. 1. For example, the learning system 1 may include only the learning device 20.

The estimation device 10 is a computer which uses a trained learning model. For example, the estimation device 10 is a personal computer, a smartphone, a tablet terminal, a wearable terminal, or a server computer. A control unit 11 includes at least one processor. A storage unit 12 includes a volatile memory such as a RAM, and a nonvolatile memory such as a hard disk drive. A communication unit 13 includes at least one of a communication interface for wired communication or a communication interface for wireless communication. A photographing unit 14 includes at least one camera.

The learning device 20 is a computer which creates a trained learning model. For example, the learning device 20 is a personal computer, a smartphone, a tablet terminal, a wearable terminal, or a server computer. Physical configurations of a control unit 21, a storage unit 22, and a communication unit 23 may be the same as those of the control unit 11, the storage unit 12, and the communication unit 13, respectively. An operating unit 24 is an input device, such as a keyboard or a mouse. A display unit 25 is a liquid crystal display or an organic EL display.

Programs stored in each of the storage units 12 and 22 may be supplied thereto via the network. Further, the estimation device 10 or the learning device 20 may include a reading unit (for example, an optical disc drive or a memory card slot) for reading a computer-readable information storage medium, or an input/output unit (for example, a USB port) for inputting and outputting data to/from an external device. For example, the program stored in the information storage medium may be supplied through intermediation of the reading unit or the input/output unit.

### 2. Overview of Learning System

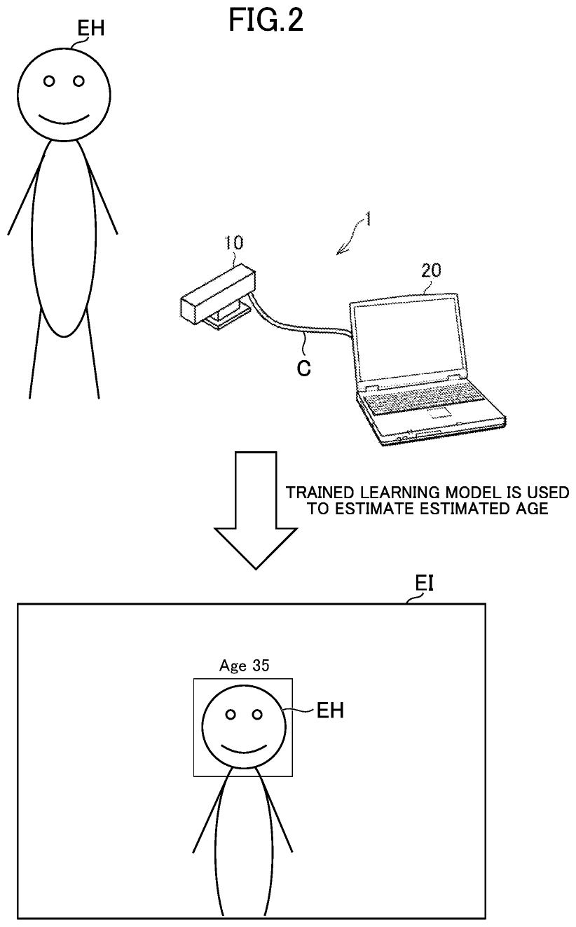

FIG. 2 is a diagram for illustrating an example of how a trained learning model is used. In this embodiment, as an example of the learning model, there is described a learning model which estimates the age of a certain human based on an image obtained by photographing the face of the human. The learning device 20 transmits the trained learning model to the estimation device 10. The estimation device 10 records the trained learning model received from the learning device 20 in the storage unit 12.

The estimation device 10 uses the photographing unit 14 to photograph an estimation-target human EH, who is a human for which his or her age is to be estimated. In this embodiment, there is described a case in which the photographing unit 14 photographs the estimation-target human EH in a moving-image mode, but the photographing unit 14 may photograph the estimation-target human EH in a still-image mode. The estimation device 10 estimates an estimated age, which is the age of the estimation-target human EH, based on an estimation-target image EI in which the estimation-target human EH is shown and the trained learning model. The estimation-target image EI shows the face of the estimation-target human EH.

The estimated age can be used for any purpose. For example, when the estimation-target human EH is a customer of a shop, the estimated age may be estimated for the purpose of grasping the customer base of the shop, for the purpose of confirming the age of a customer who is purchasing products, such as alcohol or tobacco, or for the purpose of presenting to the customer advertisements appropriate to his or her age. In addition, the estimated age may be estimated for the purpose of verifying the identity of a person at a facility, such as an airport or an event venue.

In order to create a trained learning model, the learning device 20 causes the learning model to learn training data in which training images and ground-truth ages are associated. The training images are images used by the learning model to learn. Each training image shows a human having a feature to be learned by the learning model. The ground-truth age is the age of the human shown in the training image. In this embodiment, a pair of a training image and a ground-truth age corresponds to a piece of training data.

The human shown in the training image is hereinafter referred to as “training human.” In order to improve the accuracy of the learning model, it is desired to select a wide variety of humans as the training humans. However, in this case, it is required to prepare a large amount of training data, which is very time-consuming. Thus, in this embodiment, metric learning is used to enable a highly accurate learning model to be created even when there is a small amount of training data.

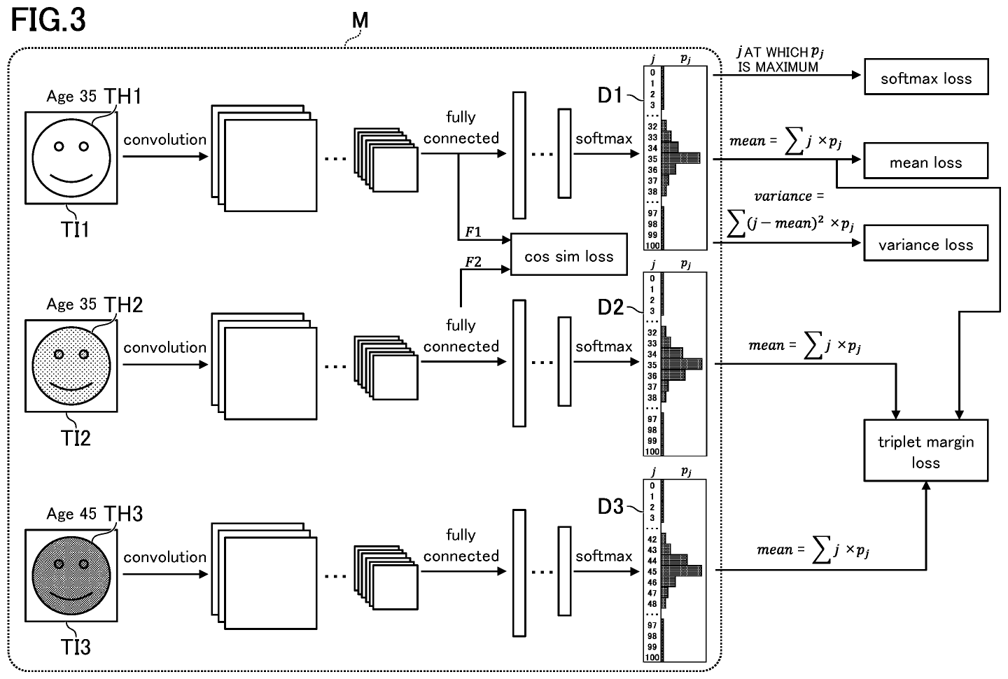

FIG. 3 is a diagram for illustrating an example of learning processing of the learning model. In the example of FIG. 3, a first training image TI1 relating to a first training human TH1 who is 35 years old, a second training image TI2 relating to a second training human TH2 who is 35 years old, and a third training image TI3 relating to a third training human TH3 who is 45 years old are used. When the first training human TH1 to the third training human TH3 are not distinguished from each other, the training humans are simply referred to as “training human TH.” Similarly, when the first training image TI1 to the third training image TI3 are not distinguished from each other, the training images are simply referred to as “training image TI.” The training image TI shows the face of the training human TH.

In this embodiment, a case in which a learning model M is a convolutional neural network is taken as an example. In FIG. 3, there is mainly illustrated processing of convolutional layers, fully connected layers, and output layers in the learning model M. The learning model M itself can use various machine learning methods, and is not limited to a convolutional neural network. For example, a recurrent neural network, a deep neural network, a generative adversarial network, or a long short-term memory model may be used. The machine learning method can use any of supervised learning, semi-supervised learning, or unsupervised learning.

For example, when the first training image TI1 is input, the convolutional layer of the learning model M executes convolution on the first training image TI1. The fully connected layer of the learning model M fully connects with the calculation result from the convolutional layer. The output layer of the learning model M outputs an estimation result of the age of the first training human TH1 based on an activation function. Similarly, when the second training image TI2 and the third training image TI3 are input, the learning model M outputs the estimation results of the ages of the second training human TH2 and the third training human TH3.

In this embodiment, the learning model M outputs a probability distribution as the estimation result of the age. The probability distribution output when the first training image TI1 is input is hereinafter referred to as “first distribution D1,” the probability distribution output when the second training image TI2 is input is referred to as “second distribution D2,” and the probability distribution output when the third training image TI3 is input is referred to as “third distribution D3.” When the first distribution D1, the second distribution D2, and the third distribution D3 are not distinguished from each other, those distributions are simply referred to as “probability distribution D.”

In the probability distribution D, for each age “j” within a certain range (“j” is an integer of 0 or more, and in FIG. 3, “j” is an integer of from 0 to 100), a probability pj indicating the probability of the training human TH being that age is shown. The probability pj may also be referred to as a likelihood or a score. In this embodiment, it is assumed that the total value of the probability pj for all ages is 100%, but when the probability pj is expressed in another unit other than percentage, the total value of the probability pj for all ages may be another value. In the example of FIG. 3, the accuracy of the learning model M is somewhat high, and thus in any of the probability distributions D, the probability pj of the age “j” being the ground-truth age is the highest. However, in a case in which the learning processing is still in the middle of being executed, the probability pj of the age “j” being the ground-truth age may not always be the highest.

The learning device 20 executes the learning processing based on the processing result of the current learning model M so as to obtain the ideal processing result. In this embodiment, there is described a case in which both an intermediate processing result of the learning model M and a final processing result of the learning model M are used as the processing result. The learning device 20 executes the learning processing so that a loss, which is a difference between the current processing result and the ideal processing result, is reduced.

In this embodiment, five types of loss are described as examples of loss, that is, a softmax loss, a mean loss, a variance loss, a cosine similarity loss (“cos sim loss” in FIG. 3), and a triplet margin loss. The softmax loss, the mean loss, and the variance loss are losses within a certain one training image TI. The cosine similarity loss and the triplet margin loss are losses relating to a mutual relationship among a plurality of training images TI.

For example, the learning device 20 calculates the softmax loss, the mean loss, and the variance loss based on the first training image TI1. The softmax loss is a loss corresponding to the difference between the age “j” at which the probability pj is the highest in the first distribution D1 and the ground-truth age (in FIG. 3, 35 years old). The mean loss is a loss corresponding to the difference between the average age calculated based on the probability distribution D and the ground-truth age. The variance loss is a loss corresponding to the difference between the age “j” and the mean loss. In FIG. 3, there is illustrated an example of a calculation expression for each loss, but various calculation expressions can be used as the calculation expression for each loss.

For example, the learning device 20 calculates the cosine similarity loss based on the first training image TI1 and the second training image TI2. The cosine similarity loss is a loss corresponding to the cosine similarity between a first feature amount F1 of the first training image TI1 calculated by the fully connected layer of the learning model M and a second feature amount F1 of the second training image TI1 calculated by the fully connected layer of the learning model M. In this embodiment, the first training human TH1 and the second training human TH2 have the same age as each other, and hence it is desired that the cosine similarity be high. Thus, as the cosine similarity is higher, the cosine similarity loss is lower.

For example, the learning device 20 calculates the triplet margin loss based on the first training image TI1, the second training image TI2, and the third training image TI3. In this embodiment, the first training human TH1 and the second training human TH2 have the same age as each other, and hence it is desired that the processing result based on the first training image TI1 and the processing result based on the second training image TI2 be similar. Conversely, the first training human TH1 and the third training human TH3 have the same age as each other, and hence it is desired that the processing result based on the first training image TI1 and the processing result based on the third training image TI3 be dissimilar. The triplet margin loss corresponding to the relationship among those three processing results is calculated.

In this embodiment, the learning processing is executed so that the total loss, which is the sum of the softmax loss, the mean loss, the variance loss, the cosine similarity loss, and the triplet margin loss, decreases. The learning system 1 uses losses related to metric learning, such as the cosine similarity loss and the triplet margin loss, to thereby increase the accuracy of the learning model M even when the amount of training data is small. Description is now given of the details of the learning system 1.

### 3. Functions Implemented in Learning System

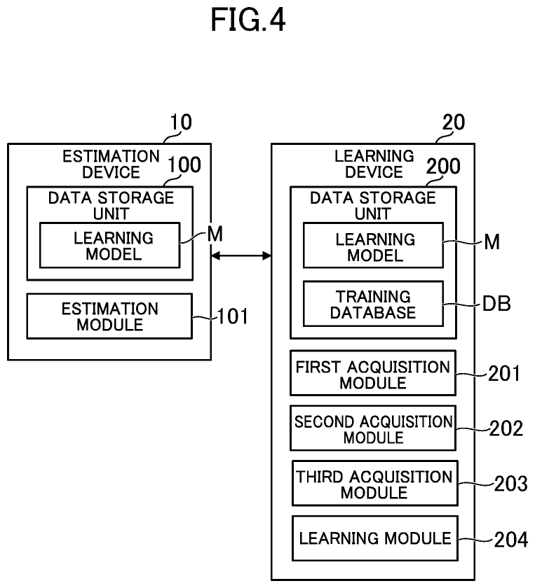

FIG. 4 is a functional block diagram for illustrating an example of functions implemented in the learning system 1.

### 3-1. Functions Implemented in Estimation Device

A data storage unit 100 is mainly implemented by the storage unit 12. An estimation module 101 is mainly implemented by the control unit 11.

### [Data Storage Unit]

The data storage unit 100 stores the data required for estimating the age of the estimation-target human EH. For example, the data storage unit 100 stores the trained learning model M. The data storage unit 100 can store any other data as well as the trained learning model M. For example, the data storage unit 100 may store the estimation-target image EI and the age estimated by the trained learning model M in association with each other.

### [Estimation Module]

The estimation module 101 estimates the estimated age of the estimation-target human EH based on the estimation-target image EI and the trained learning model M. In this embodiment, there is described a case in which the estimation module 101 acquires the estimation-target image EI generated by the photographing unit 14. However, the estimation module 101 may acquire the estimation-target image EI from another computer or another information storage medium other than that of the estimation device 10. The estimation module 101 inputs the estimation-target image EI to the trained learning model M.

For example, the convolutional layer of the learning model M executes convolution of the input estimation-target image EI. The fully connected layer of the learning model M fully connects with the execution result of the convolution, and acquires a feature amount to be estimated, which is the feature amount of the estimation-target image EI. The output layer of the learning model M outputs an estimation result of the estimated age based on the feature amount to be estimated. Those processing steps are executed based on parameters adjusted by a learning module 204, which is described later.

In this embodiment, description is given of an example in which the output layer of the learning model M outputs the probability distribution D as the estimation result, and the estimation module 101 estimates the age “j” of the highest probability pj in the probability distribution D as the estimated age. The method of estimating the age of the estimation-target human EH may be another method, and the method is not limited to the example of this embodiment. For example, the estimation module 101 may estimate the age “j” having the second or subsequent highest probability pj as the estimated age. For example, the estimation module 101 may estimate an average age calculated based on the age “j” of the probability distribution D and the probability pj as the age of the estimation-target human EH.

The estimation result output by the output layer of the learning model M may be another estimation result other than the probability distribution D, and is not limited to the probability distribution D. The processing described as being executed by the estimation module 101 based on the probability distribution D may be executed by the output layer of the learning model M, and the execution result of the processing may be output. For example, the output layer of the learning model M may identify the age “j” of the highest probability pj in the probability distribution D, and output the identified age “j.” For example, the output layer of the learning model M may calculate an average age and output the calculated average age. It is possible to output such an estimation result by replacing the output layer of the trained learning model M.

### 3-2. Functions Implemented in Learning Device

A data storage unit 200 is implemented mainly by the storage unit 22. A first acquisition module 201, a second acquisition module 202, a third acquisition module 203, and the learning module 204 are mainly implemented by the control unit 21.

### [Data Storage Unit]

The data storage unit 200 stores the data required for the learning processing of the learning model M. For example, the data storage unit 200 stores a learning model M before learning processing is complete and a training database DB. Before the start of the learning processing, the data storage unit 200 stores a learning model M in which the parameters are set to initial values. When the learning processing is being executed, the data storage unit 200 stores a learning model M in which the parameters are being adjusted. After the learning processing is complete, the data storage unit 200 stores the trained learning model M.

The data storage unit 200 may store a plurality of learning models M which share parameters with each other. For example, the processing of FIG. 3 may be executed based on a plurality of learning models M in place of being executed based on one learning model M. When it is assumed that a first learning model M1, a second learning model M2, and a third learning model M3 share parameters with each other, the first training image TI1 may be input to the first learning model M1, the second training image TI2 may be input to the second learning model M2, and the third training image TI3 may be input to the third learning model M3. When the parameters of any of the first learning model M1, the second learning model M2, and the third learning model M3 change due to the learning processing, the parameters of the remaining two learning models also change to the same value.

In this embodiment, the learning model M is a convolutional neural network, and thus the data storage unit 200 stores a program for the learning model M which includes a convolutional layer, a fully connected layer, and an output layer. The parameters of the learning model M may be integrated with each layer (program portion) of the learning model M as data, or may be separate. Even when a machine learning method other than a convolutional neural network is used, the data storage unit 200 may store a learning model M having a format corresponding to the other machine learning method.

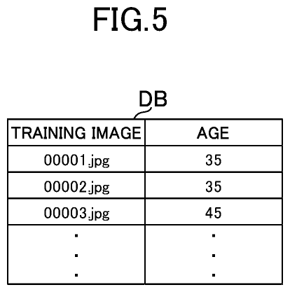

FIG. 5 is a table for showing an example of the training database DB. The training database DB is a database which stores a plurality of pieces of training data. For example, the training data includes pairs of the training image TI relating to a certain training human TH and the age of the training human TH. In this example, the format of each training image TI is the same, but the format may be slightly different. As used herein, “format” refers to a format of the image data. For example, the format is a file extension, a resolution (number of pixels), an aspect ratio, the number of colors, or a combination thereof. Only a part of the face of the training human TH may be shown in the training image TI.

In this embodiment, there is described a case in which the creator of the learning model M creates the training database DB, but various methods can be used to create the training data. There also exist methods of automating the creation of training data by using clustering or the like, and hence such methods may be used to automate the creation of the training data. It suffices for the training image TI to show an object corresponding to a first object, for example, which is described later. Thus, another object other than a human may be shown in the training image TI.

In this embodiment, it is assumed that the application of the training image TI stored in the training database DB is not specified. As used herein, “application” refers to whether the training image TI is used as a first training image TI1, a second training image TI2, or a third training image TI3. When the application of the training image TI is not limited as in this embodiment, the training image TI can be any of the first training image TI1, the second training image TI2, and the third training image TI3.

The creator of the learning model M may specify the application of each training image TI. In this case, the training database DB stores information which can identify the application specified by the creator. Separate databases may be prepared for each application. For example, a first database storing only first training images TI1, a second database storing only second training images TI2, and a third database storing only third training images TI3 may be prepared. As another example, separate databases may be prepared for each age of the training human TH.

### [First Acquisition Module]

The first acquisition module 201 acquires a first training image TI1 relating to the first training human TH1 of a first age. The first acquisition module 201 can acquire any first training image TI1 from the training database DB. For example, the first acquisition module 201 may randomly acquire the first training image TI1. The first acquisition module 201 may acquire a first training image TI1 of an age which the learning model M has not yet learned. The first acquisition module 201 may acquire a first training image TI1 of an age having a relatively small number of images learned by the learning model M.

The first age is the age of the first training human TH1. The first age is an example of a first numerical value. Thus, “first age” as used in this embodiment can be read as “first numerical value.” The first numerical value is a numerical value relating to the first training human TH1. The first numerical value is not limited to age, and may be any numerical value relating to the first human H. The first numerical value may be a numerical value representing a feature of the first human H. For example, the first numerical value may be the height, weight, size of a body part (for example, head, legs, or torso), or a body shape of the first human H. In this embodiment, description is given of an example in which the first numerical value is the same as a second numerical value described later. Further, description is given of an example in which the first numerical value is different from a third numerical value described later.

The first training human TH1 is the human shown in the first training image TI1. The first training human TH1 is an example of the first object. Thus, “first training human TH1” as used in this embodiment can be read as “first object.” The first object is the object shown in the first training image TI1. When the first training image TI1 is a photographic image generated by a camera, the first object is a subject arranged in a real space. When the first training image TI1 is a computer graphics image, the first object is a 3D object arranged in a virtual space or an object such as a two-dimensionally drawn character. Only a part of the face of the first training human TH may be shown in the first training image TI1. This point also applies to the second training image TI2 and the third training image TI3.

The first object may be another object other than a human. For example, the first object may be another animal, such as a dog or a cat. In this case, the another animal is shown in the first training image TI1. The first training image TI1 is associated with the age of the another animal. The learning model M estimates the age of the another animal. Even when the first object is another animal, the learning model M may estimate another numerical value, for example, body length, weight, size, or body shape, of the another animal instead of the age.

Further, the first object may be another object other than an animal. For example, the first object may be a plant, furniture, an indoor wall, a food or drink, a vehicle, a building, or other scenery in the natural world. In this case, the first training image TI1 includes such another object. When the first object is another object, such as a plant or a building, that has a concept equivalent to age (age of a tree or age of a building), the learning model M estimates this concept. In the case of other objects for which such a concept does not exist, the learning model M may estimate another numerical value, such as the weight or size, of the another object.

### [Second Acquisition Module]

The second acquisition module 202 acquires a second training image TI2 relating to the second training human TH2 of a second age. The second acquisition module 202 can acquire any second training image TI2 from the training database DB. In this embodiment, there is described a case in which the second acquisition module 202 acquires, from the training database DB, a second training image TI2 suitable for use in metric learning together with the first training image TI1. However, the second acquisition module 202 may randomly acquire the second training image TI2 regardless of the first training image TI1.

The second age is the age of the second training human TH2. The second age is an example of a second numerical value. Thus, “second age” as used in this embodiment can be read as “second numerical value.” Similarly to the first numerical value, the second numerical value is not limited to age.

The second training human TH2 is a human shown in the second training image TI2. The second training human TH2 is an example of the second object. Thus, “second training human TH2” as used in this embodiment can be read as “second object.” The second object is an object shown in the second training image TI2. Similarly to the first object, the second object is not limited to a human.

In this embodiment, there is described a case in which the first object and the second object are of different training humans TH, but the first object and the second object may be of the same training human TH. For example, a certain training human TH may be photographed with a certain expression in the first training image TI1, and the training human TH may be photographed with a different expression in the second training image TI2. As another example, a certain training human TH may be photographed from a certain angle in the first training image TI1, and the training human TH may be photographed from a different angle in the second training image TI2.

In this embodiment, when the first training image TI1 showing the first training human TH1 of a certain first age is acquired, the second acquisition module 202 retrieves a training image TI of a second age that is the same as the first age from the training database DB, and acquires the training image TI as the second training image TI2. When a plurality of training images TI are found in the search, the second acquisition module 202 may acquire any of the plurality of training images TI as the second training image TI2.

In a case in which the creator specifies the second age before the first training image TI1 is acquired, the second acquisition module 202 may acquire the second training image TI2 before the first training image TI1 is acquired. As another example, in a case in which a combination of the first training image TI1 and the second training image TI2 to be used together in metric learning is associated in advance in the training database DB, the second acquisition module 202 may acquire the second training image TI2 that is associated with the first training image TI1.

### [Third Acquisition Module]

The third acquisition module 203 acquires a third training image TI3 relating to the third training human TH3 of a third age. The third acquisition module 203 can acquire any third training image TI3 from the training database DB. In this embodiment, there is described a case in which the third acquisition module 203 acquires, from the training database DB, a third training image TI3 suitable for use in metric learning together with the first training image TI1 and the second training image TI2. However, the third acquisition module 203 may randomly acquire the third training image TI3 regardless of the first training image TI1 and the second training image TI2.

The third age is the age of the third training human TH3. The third age is an example of a third numerical value. Thus, “third age” as used in this embodiment can be read as “third numerical value.” Similarly to the first numerical value and the second numerical value, the third numerical value is not limited to age.

The third training human TH3 is a human shown in the third training image TI3. The third training human TH3 is an example of the third object. Thus, “third training human TH3” as used in this embodiment can be read as “third object.” The third object is an object shown in the third training image TI3. Similarly to the first object and the second object, the third object is not limited to a human.

In this embodiment, there is described a case in which the third object and the first and second objects are of different training humans TH, but the third object and the first and second objects may be of the same training human TH. For example, in the first training image TI1 or the second training image TI2, an old appearance of a certain training human TH (for example, when the training human TH was 20 years old) may be shown, and in the third training image 12, a recent appearance of the training human TH (for example, when the training human TH was 40 years old) may be shown.

For example, when the first training image TI1 showing the first training human TH1 of a certain first age is acquired, the third acquisition module 203 retrieves a training image TI of a third age that is different from the first age from the training database DB, and acquires the training image TI as the third training image TI3. When a plurality of training images TI are found in the search, the third acquisition module 203 may acquire any of the plurality of training images TI as the third training image TI2.

In this embodiment, it is assumed that the difference between the first age and the third age is fixed at 10 years, but the difference between the first age and the third age may change dynamically. For example, in a case in which a face feature changes more with age as the first age becomes younger, the difference between the first age and the third age may be smaller. Conversely, in a case in which a face feature changes less with age as the first age becomes younger, the difference between the first age and the third age may be larger. The third acquisition module 203 may determine the third age based on the first age of the first training image TI1, and retrieve a third training image TI3 of the determined third age.

In a case in which the creator specifies the third age before the first training image TI1 is acquired, the third acquisition module 203 may acquire the third training image TI3 before the first training image TI1 is acquired. As another example, in a case in which a combination of the first training image TI1, the second training image TI2, and the third training image TI3 to be used together in metric learning is associated in advance in the training database DB, the third acquisition module 203 may acquire the third training image TI3 that is associated with the first training image TI1 and the second training image TI2.

### [Learning Module]

The learning module 204 executes the learning processing of the learning model M which estimates the estimated age relating to the estimation-target human EH included in the estimation-target image EI based on metric learning which uses the first training image TI1 and the second training image TI2.

Metric learning is a learning method based on a mutual relationship among a plurality of pieces of training data. For example, in metric learning, learning processing is executed so that the same or similar pieces of training data become closer to each other. For example, in metric learning, learning processing is executed so that dissimilar pieces of training data become further away from each other. In this embodiment, there is described a case in which metric learning includes both of those methods, but metric learning may also mean only one of those methods.

Various methods can be used for the metric learning itself, and for example, a Euclidean distance method, a Mahalanobis distance method, or an angle method can be used. The learning module 204 may execute the learning processing of the learning model M by using a method of deep metric learning. As described above, the learning module 204 in this embodiment executes the learning processing of the learning model M.

The estimation-target human EH is an example of an object to be estimated. Thus, “estimation-target human EH” as used in this embodiment can be read as “object to be estimated.” The object to be estimated is an object shown in the estimation-target image EI. Similarly to the first object, the second object, and the third object, the object to be estimated is not limited to a human.

The estimated age is an example of a numerical value to be estimated. Thus, “estimated age” as used in this embodiment can be read as “numerical value to be estimated.” Similarly to the first to third numerical values, the numerical value to be estimated is not limited to age.

The learning processing is processing of adjusting the parameters of the learning model M based on the training data. In this embodiment, the learning model M is a convolutional neural network, and thus the learning processing is processing of adjusting parameters, such as a weighting coefficient or a bias. The learning processing itself may be any processing which is compatible with the machine learning method used as the learning model M, and is not limited to the example of this embodiment. In the learning processing, the parameters corresponding to the machine learning method may be adjusted.

In this embodiment, there is described a case in which the learning module 204 executes the learning processing based on metric learning using the first training image TI1, the second training image TI2, and the third training image TI3. However, the learning module 204 may execute the learning processing based on the first training image TI1 and the second training image TI2, without using the third training image TI3. The learning module 204 may execute the learning processing based on two or more training images TI. For example, the learning module 204 may execute the learning processing based on four or more training images TI.

The learning module 204 may execute the learning processing by using another method other than metric learning as well. In this embodiment, a method using a softmax loss, a mean loss, and a variance loss is described as an example of the another method. Various methods can be used as the another method itself, and the another method is not limited to the example of this embodiment. As an example of the metric learning, description is given of a method using a cosine similarity loss and a method using a triplet margin loss.

### [Method Using Softmax Loss, Mean Loss, and Variance Loss]

First, description is given of a method using a softmax loss, a mean loss, and a variance loss. Those three losses are examples of a first loss. Thus, “softmax loss,” “mean loss,” or “variance loss” as used in this embodiment can be read as “first loss.” The first loss is a loss relating to the difference between the processing result of the current learning model M based on a certain training image TI and an ideal processing result. When the first loss is to be calculated by using a certain training image TI, other training images TI are not used.

For example, the learning module 204 acquires a first processing result obtained by the learning model M based on the first training image TI1. The first processing result is the result of processing executed when the first training image TI1 is input to the learning model M. Description is given here of a case in which the first processing result is a first estimation result obtained by the learning model M, but the first processing result may be an internal calculation result of the learning model M. That is, a case in which the first processing result is an output from the output layer is described, but the first processing result may be an output from an intermediate layer.

The first estimation result is the estimated age output from the learning model M when the first training image TI1 is input to the learning model M. In this embodiment, the first estimation result is a first distribution D1 which includes each of a plurality of ages “j” and a first probability pj that the first training human TH1 has the age. The plurality of ages “j” are an example of a plurality of numerical values. Thus, “plurality of ages ‘j’” as used in this embodiment can be read as “plurality of numerical values.” The age “j” having the highest probability pj, the average age of the first distribution D1, or the average variance of the first distribution D1 may correspond to the first estimation result. The first estimation result is not limited to those examples, and, for example, an age “j” having the second or subsequent highest probability pj may correspond to the first estimation result.

In this embodiment, the learning module 204 calculates a plurality of first losses based on the first distribution D1, which is the first estimation result, and the first age. For example, the learning module 204 identifies the age “j” having the highest probability pj based on the first distribution D1, which is the first estimation result. The learning module 204 acquires the difference between the identified age “j” and the first age as the softmax loss. The learning module 204 calculates the average age based on the first distribution D1 and the calculation expression illustrated in FIG. 3. The learning module 204 acquires the difference between the calculated average age and the first age as the mean loss. The learning module 204 calculates the average variance based on the first distribution D1 and the calculation expression illustrated in FIG. 3. The learning module 204 acquires the difference between the calculated average variance and the ideal variance corresponding to the first age as the variance loss.

### [Method Using Cosine Similarity Loss]

Next, description is given of a method using a cosine similarity loss. The learning module 204 acquires a second processing result obtained by the learning model M based on the second training image TI2. The second processing result is the result of processing executed when the second training image TI2 is input to the learning model M. Similarly to the first processing result, the second processing result may be an internal calculation result of the learning model M, or may be a second estimation result output from the learning model M. Description is given here of an example in which, in the calculation of the cosine similarity loss, the first processing result and the second processing result are both internal calculation results of the learning model M.

The second estimation result is the age estimated by the learning model M when the second training image TI2 is input to the learning model M. In this embodiment, the second estimation result is a second distribution D2 which includes each of a plurality of ages “j” and a second probability pj that the second training human TH2 has the age. Similarly to the first estimation result, the second estimation result may be another estimation result other than the probability distribution D. The another estimation result may be the same as those given as examples in the description of the first estimation result.

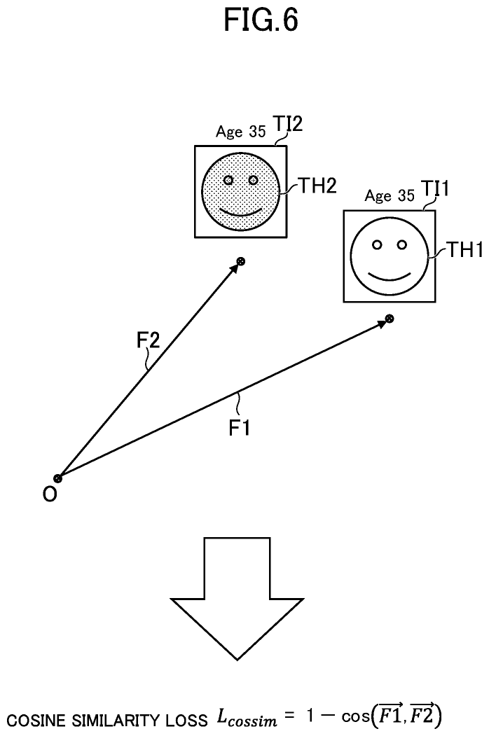

FIG. 6 is a diagram for illustrating an example of a method in which a cosine similarity loss is used. For example, the learning module 204 calculates the first feature amount F1 relating to the first training image TI1 based on the first training image TI1 and the learning model M. For example, the learning module 204 calculates the second feature amount F2 relating to the second training image TI2 based on the second training image TI2 and the learning model M. In FIG. 6, the first feature amount F1 and the second feature amount F2 are shown in a multidimensional vector space having an origin O.

The first feature amount F1 is information relating to the feature of the first training image TI1. The second feature amount F2 is information relating to the feature of the second training image TI2. In this embodiment, there is described a case in which the first feature amount F1 and the second feature amount F2 are represented as multidimensional vectors, but the first feature amount F1 and the second feature amount F2 can be represented in any format. For example, the first feature amount F1 and the second feature amount F2 may be represented in other formats, such as an array or a single numerical value.

In this embodiment, there is described a case in which the learning model M is a convolutional neural network, and thus the learning module 204 calculates the first feature amount F1 by convolving the first training image TI1 based on the parameters of the current learning model M. The learning module 204 calculates the second feature amount F2 by convolving the second training image TI2 based on the parameters of the current learning model M. The calculation method for the first feature amount F1 and the second feature amount F2 is as described with reference to FIG. 3. The calculation method itself for the first feature amount F1 and the second feature amount F2 may be a calculation method that is compatible with the machine learning method used as the learning model M, and various methods can be used.

For example, the learning module 204 executes the learning processing based on the first feature amount F1 and the second feature amount F2. In this embodiment, the learning module 204 calculates a cosine similarity based on the first feature amount F1 and the second feature amount F2. The learning module 204 executes the learning processing based on the calculated cosine similarity. The learning module 204 executes the learning processing so that the cosine similarity loss corresponding to the cosine similarity becomes smaller (the cosine similarity becomes larger). The expression for calculating the cosine similarity loss is as illustrated in FIG. 6. That is, the learning module 204 executes the learning processing so that the difference between the first processing result and the second processing result becomes smaller.

The cosine similarity loss is an example of a related loss. Thus, “cosine similarity loss” as used in this embodiment can be read as “related loss.” The related loss is a loss relating to a relationship among a plurality of training images TI. The learning module 204 calculates the related loss based on the relationship between the first processing result of the learning model M based on the first training image TI1 and the second processing result of the learning model M based on the second training image TI2. The related loss itself may be any loss, and is not limited to a cosine similarity loss. For example, the related loss may be a loss calculated by using a Euclidean distance method or a loss calculated by using a Mahalanobis distance method.

The learning module 204 may calculate a third feature amount relating to the third training image TI3 based on the third training image TI3 and the learning model M. In this case, the learning module 204 may calculate a cosine similarity based on the first feature amount and the third feature amount, and may execute the learning processing based on the calculated cosine similarity. That is, the learning module 204 may execute the learning processing so that a difference between the first processing result and a third processing result becomes larger. By combining the above, the learning module 204 may execute the learning processing so that the difference between the first processing result and the second processing result becomes smaller and the difference between the first processing result and the third processing result becomes larger.

The learning module 204 may calculate a cosine similarity based on the second feature amount and the third feature amount, and may execute the learning processing based on the calculated cosine similarity. The learning module 204 may execute the learning processing so that this cosine similarity becomes lower. That is, the learning module 204 may execute the learning processing so that the difference between the second processing result and the third processing result becomes larger. By combining the above, the learning module 204 may execute the learning processing so that the difference between the first processing result and the second processing result becomes smaller, the difference between the first processing result and the third processing result becomes larger, and the difference between the second processing result and the third processing result becomes larger.

### [Triplet Margin Loss]

Lastly, description is given of a method using a triplet margin loss. The learning module 204 acquires a third processing result obtained by the learning model M based on the third training image TI3. The third processing result is the result of processing executed when the third training image TI3 is input to the learning model M. Description is given here of a case in which the third processing result is a third estimation result obtained by the learning model M, but the third processing result may be an internal calculation result of the learning model M. That is, a case in which the third processing result is an output from the output layer is described, but the third processing result may be an output from an intermediate layer.

The third estimation result is the age estimated by the learning model M when the third training image TI3 is input to the learning model M. In this embodiment, the third estimation result is a third distribution D3 which includes each of a plurality of ages “j” and a third probability pj that the third training human TH3 has the age “j”. Similarly to the first estimation result and the second estimation result, the third estimation result may be another estimation result other than the probability distribution D. The another estimation result may be the same as those given as examples in the description of the first estimation result. In this embodiment, it is assumed that the triplet margin loss is calculated based on the first estimation result, the second estimation result, and the third estimation result.

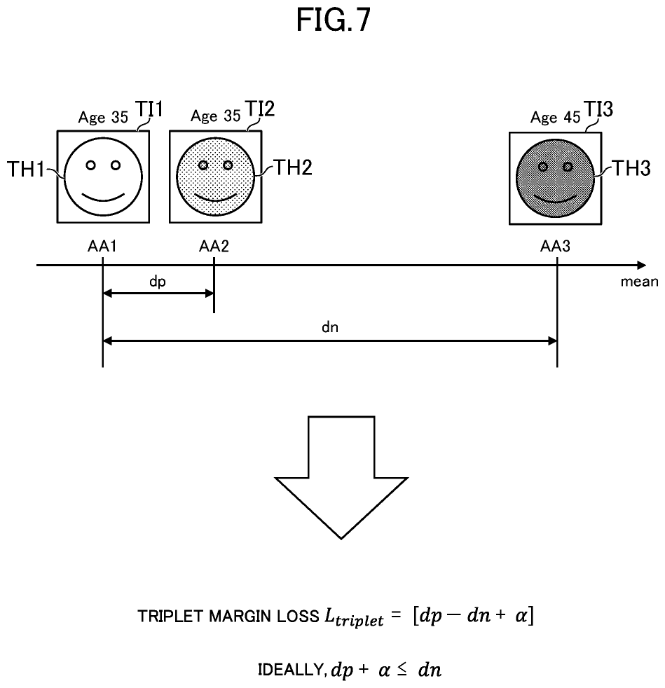

FIG. 7 is a diagram for illustrating an example of a method in which a triplet margin loss is used. In this embodiment, the first training image TI1 corresponds to an anchor image which serves as a reference when the triplet margin loss is calculated. The second training image TI2 is associated with the second age, which is the same as the first age, and thus the second training image TI2 corresponds to a positive image given the same label as the anchor image. The third training image TI3 is associated with a third age different from the first age, and thus the third training image TI3 corresponds to a negative image given a label different from the anchor image. In the method using the triplet margin loss, the learning processing is executed so that the anchor image and the positive image become closer and the anchor image and the negative image become farther apart.

In FIG. 7, there are illustrated a first average age AA1 calculated from the first distribution D1, a second average age AA2 calculated from the second distribution D2, and a third average age AA3 calculated from the third distribution D3. The method of calculating each of the second average age AA2 and the third average age AA3 is the same as that of the first average age AA1. The learning module 204 executes the learning processing so that a difference dp between the first average age AA1 and the second average age AA2 becomes smaller, and a difference dn between the first average age AA1 and the third average age AA3 becomes larger.

For example, the learning module 204 calculates the triplet margin loss based on the difference dp, the difference dn, and a predetermined calculation expression. An example of the calculation expression is as illustrated in FIG. 7. The calculation expression itself may be another calculation expression used for triplet margin loss. For example, when α is a hyperparameter indicating the margin in the triplet margin loss, ideally, the difference between the difference dn and the difference dp is the margin α, and hence the difference between the current difference dn and difference dp and the margin α is the triplet margin loss.

For example, by executing the learning processing so that the triplet margin loss becomes smaller, the learning module 204 executes the learning processing so that the difference between the difference dn and the difference dp approaches the margin α. In the example of FIG. 7, the difference between the first and second ages and the third age is 10 years, and thus the margin α has a value of about 10. The margin α may be a fixed value or may be determined dynamically.

The learning module 204 calculates the total loss by summing the softmax loss, the mean loss, the variance loss, the cosine similarity loss, and the triplet margin loss. The learning module 204 executes the learning processing so that the total loss becomes smaller. Various methods can be used for the learning processing itself to correspond to the loss. For example, methods, such as error backpropagation or gradient descent, may be used. In this embodiment, description is given of a case in which the total loss is a simple total value, but a weighting coefficient may be added as in the modification examples described later.

In this embodiment, the softmax loss, the mean loss, and the variance loss correspond to the first loss, and the cosine similarity loss and the triplet margin loss correspond to the related loss, and thus the learning module 204 executes the learning processing based on a first loss and a related loss. Further, a plurality of first losses, such as the softmax loss, the mean loss, and the variance loss, are used, and thus the learning module 204 executes the learning processing based on a plurality of first losses and a related loss.

As described above, in this embodiment, by using the triplet margin loss, the learning module 204 executes the learning processing based on the first estimation result, the second estimation result, and the third estimation result. For example, the learning module 204 executes the learning processing so that the difference between the first estimation result and the second estimation result becomes smaller and the difference between the first estimation result and the third estimation result becomes larger. The probability distribution D is used for each loss other than the cosine similarity loss, and thus the learning module 204 executes the learning processing based on the first distribution D1, the second distribution D2, and the third distribution D3.

The learning module 204 may calculate the triplet margin loss by using an intermediate processing result in place of the estimation result of the learning model M. That is, the learning module 204 may execute the learning processing based on the first processing result, the second processing result, and the third processing result. For example, the learning module 204 may execute the learning processing so that the difference between the first processing result and the second processing result becomes smaller and the difference between the first processing result and the third processing result becomes larger.

For example, the learning module 204 calculates a third feature amount F3 relating to the third training image TI3 based on the third training image TI3 and the learning model M. The third feature amount F3 is information relating to the feature of the third training image TI3. Similarly to the first feature amount F1 and the second feature amount F2, the third feature amount F3 can be represented in any format. The learning module 204 may execute the learning processing so that the difference between the difference dn between the first feature amount F1 and the third feature amount F3 and the difference dp between the first feature amount F1 and the second feature amount F2 approaches the margin α.

For example, the learning module 204 may execute the learning processing so that the difference between the first processing result and the third processing result corresponds to the difference between the first age and the third age. The learning module 204 may determine the margin α based on the difference between the first age and the third age. The learning module 204 determines the margin α so that as the difference between the first age and the third age becomes larger, the margin α becomes larger. The learning module 204 executes the learning processing based on the determined margin α. In the example of FIG. 7, the difference between the first age and the third age is 10 years, but when the difference between the first age and the third age is 5 years, the margin α may be a difference of about 5 years.

The learning module 204 may execute the learning processing based on a cosine similarity loss and a triplet margin loss, which are examples of the related loss, without using a softmax loss, a mean loss, or a variance loss, which are examples of the first loss. The learning module 204 may execute the learning processing based on any one of the cosine similarity loss or the triplet margin loss. The learning module 204 may execute the learning processing based on only a certain one related loss.

### 4. Processing to be Executed by Learning System 1

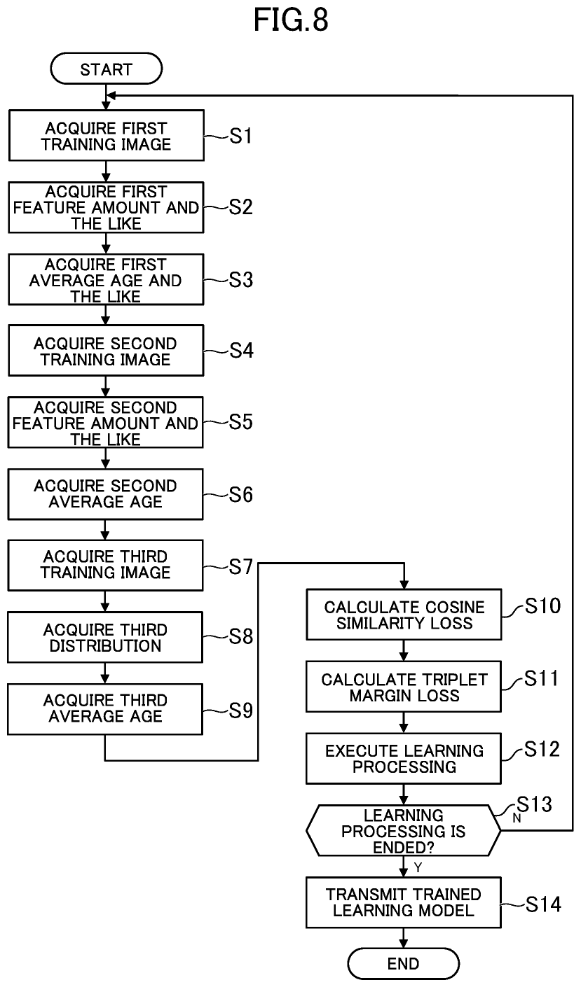

FIG. 8 is a flow chart for illustrating an example of processing to be executed by the learning system 1. In FIG. 8, processing of the learning device 20 is illustrated. The learning device 20 acquires a first training image TI1 based on the training database DB (Step S1). In Step S1, the learning device 20 acquires a training image TI that has not yet been learned by the learning model M from the training database DB as the first training image TI1.

The learning device 20 acquires the first feature amount F1 and the first distribution D1 based on the current learning model M and the first training image TI1 (Step S2). In Step S2, the learning device 20 inputs the first training image TI1 to the learning model M, and executes calculations corresponding to each layer of the learning model M. The learning device 20 acquires the first feature amount F1 calculated by the fully connected layer and the first distribution D1 output by the output layer.

The learning device 20 acquires the first average age AA1, the softmax loss, the mean loss, and the variance loss based on the first age associated with the first training image TI1 and the first distribution D1 acquired in Step S2 (Step S3). The method of calculating each of those losses is as described above. The learning device 20 acquires the second training image TI2 of the second age, which is the same as the first age, based on the training database DB (Step S4).

The learning device 20 acquires the second feature amount F2 and the second distribution D2 based on the current learning model M and the second training image TI2 (Step S5). The processing step of Step S5 differs from the processing step of Step S2 in the point that the second training image TI2 is input to the learning model M, but the other points are similar to the processing step of Step S2. The learning device 20 acquires the second average age AA2 based on the second distribution D2 (Step S6). The method of calculating the second average age AA2 is as described above.

The learning device 20 acquires the third training image TI3 of a third age different from the first age based on the training database DB (Step S7). The learning device 20 acquires the third distribution D3 based on the current learning model M and the third training image TI3 (Step S8). In Step S8, the learning device 20 inputs the third training image TI3 to the learning model M, and acquires the third distribution D3 output from the learning model M. The learning device 20 acquires the third average age AA3 based on the third distribution D3 (Step S9). The method of calculating the third average age AA3 is as described above.

The learning device 20 calculates the cosine similarity loss based on the first feature amount F1 and the second feature amount F2 (Step S10). The learning device 20 calculates the triplet margin loss based on the first average age AA1, the second average age AA2, and the third average age AA3 (Step S11). The learning device 20 executes the learning processing based on the softmax loss, the mean loss, the variance loss, the cosine similarity loss, and the triplet margin loss (Step S12).

The learning device 20 determines whether or not to end the learning processing (Step S13). The learning processing can be ended at any timing. For example, the learning processing may be ended when all of the training data in the training database DB has been learned, or may be ended when a predetermined number of pieces of the training data have been learned. When it is not determined that the learning processing is to be ended (“N” in Step S13), the process returns to Step S1. When it is determined that the learning processing is to be ended (“Y” in Step S13), the learning device 20 transmits the trained learning model M to the estimation device 10 (Step S14), and ends the processing. The estimation device 10 records the trained learning model M in the storage unit 12, and starts actual operation.

The learning system 1 of this embodiment executes the learning processing of the learning model M, which estimates the estimated age of the estimation-target human EH included in the estimation-target image EI, based on metric learning using the first training image TI1 and the second training image TI2. Through use of metric learning, efficient learning processing is possible even when the amount of training data is small, and thus the accuracy of the learning model M is improved. The creator of the learning model M is not required to prepare a large amount of training data, and hence the amount of effort required by the creator can be reduced.

Further, the learning system 1 executes the learning processing based on metric learning using the first training image TI1, the second training image TI2, and the third training image TI3. Through use of three training images TI instead of two, more efficient learning processing becomes possible, and thus the accuracy of the learning model M is further improved. A highly accurate learning model M can be created through use of less training data, and hence the amount of effort required by the creator can be further reduced.

Further, the learning system 1 executes the learning processing so that, when the first age is the same as the second numerical value and different from the third numerical value, the difference between the first processing result and the second processing result becomes smaller and the difference between the first processing result and the third processing result becomes larger. For example, the learning system 1 executes the learning processing based on the triplet margin loss calculated by using the first average age AA1 to the third average age AA3, which are examples of the first processing result to the third processing result. As a result, the learning processing can be executed by using both the relationship between a so-called anchor image and positive image and the relationship between the anchor image and negative image, and thus the accuracy of the learning model M is further improved. That is, the learning processing is executed not only such that similar training images TI are brought closer to each other, but also such that different training images TI are moved further away from each other, and thus the accuracy of the learning model M is further improved.

Further, the learning system 1 executes the learning processing so that the difference between the first processing result and the third processing result becomes a difference corresponding to the difference between the first age and the third age. For example, the margin α in the triplet margin loss is determined so as to be a value corresponding to the difference between the first age and the third age. As a result, as compared to related-art metric learning, in which the learning processing is executed so that images having different labels are simply moved further away from each other, the learning processing is executed so that the difference between a first processing result and a third processing result becomes a difference corresponding to an age difference, and thus the accuracy of the learning model M is further improved. That is, by adjusting how far the images are to be moved away from each other in accordance with an age difference through use of the properties of the learning model M, such as estimating an estimated age, it is possible to perform optimal learning processing, and thus the accuracy of the learning model M can be further improved.

Further, the learning system 1 executes the learning processing based on the first estimation result, the second estimation result, and the third estimation result. For example, the learning system 1 executes the learning processing based on the triplet margin loss calculated by using the first average age AA1 to the third average age AA3, which are examples of the first estimation result to the third estimation result. As a result, optimal learning processing can be executed in consideration of the mutual relationships among three training images TI, and thus the accuracy of the learning model M can be further improved.

Further, the learning 1 executes the learning processing based on the first distribution D1, the second distribution D2, and the third distribution D3. For example, the learning system 1 executes the learning processing based on the first distribution D1 to the third distribution D3 which include a probability pj corresponding to each age “j” of from 0 to 100 years old, which can be estimated by the learning model M. As a result, the learning processing can be executed by giving even more optimal consideration to the estimation result of the current learning model M, and thus the accuracy of the learning model M can be further improved.

Further, the learning system 1 executes the learning processing based on the first feature amount F1 and the second feature amount F2. As a result, an intermediate calculation result of the learning model M can be used for the learning processing, and thus the accuracy of the learning model M can be further improved.

Further, the learning system 1 calculates a cosine similarity based on the first feature amount F1 and the second feature amount F2, and executes the learning processing based on the calculated cosine similarity. As a result, it is possible to use a cosine similarity which can be used to more accurately evaluate the accuracy of the current learning model M, and thus the accuracy of the learning model M can be further improved.

Further, the learning system 1 executes the learning processing based on the first loss and the related loss. For example, the learning system 1 executes the learning processing based on the softmax loss, the mean loss, and the variance loss, which correspond to the first loss, and the cosine similarity loss and the triplet margin loss, which correspond to the related loss. As a result, the learning processing can be executed by evaluating the accuracy of the current learning model M in a more multifaceted manner, and thus the accuracy of the learning model M can be further improved.

Further, the learning system 1 executes the learning processing based on a plurality of the first losses and the related loss. For example, the learning system 1 executes the learning processing based not on a single first loss but on a plurality of first losses, such as the softmax loss, the mean loss, and the variance loss. As a result, the learning processing can be executed by evaluating the accuracy of the current learning model M in a more multifaceted manner, and thus the accuracy of the learning model M can be further improved.

Further, in this embodiment, the first object and the second object are different humans. The first numerical value is the age of the first object. The second numerical value is the age of the second object. The object to be estimated is the human for which his or her age is to be estimated. The numerical value to be estimated is the age of the object to be estimated. This improves the accuracy of the learning model M which estimates the estimated age, and the learning model M can accurately estimate the estimated age of the estimation-target human EH. As a result, it becomes easier to achieve the purpose of using the learning model M. For example, when the estimation-target human EH is a customer of a shop, it becomes possible to more accurately grasp the customer base of the shop, more accurately confirm the age of a customer who is purchasing products, such as alcohol or tobacco, and present to the customer advertisements that are the most suitable for his or her age. For example, when the age of the estimation-target human EH is to be estimated for the purpose of verifying the identity of a person at a facility, such as an airport or an event venue, more accurate identity verification becomes possible.

### 5. Modification Examples

The present disclosure is not limited to the embodiment described above, and can be modified suitably without departing from the spirit of the present disclosure.

### 5-1. Modification Example 1

For example, in the embodiment, description is given of an example in which the first age is the same as the second age, but the first age may be different from the second age. In Modification Example 1 of the present disclosure, description is given of an example in which the first age is different from both the second age and the third age. However, the second age is different from the third age. The difference between the first age and the third age is larger than the difference between the first age and the second age. In Modification Example 1, in the example of FIG. 3, the second age is 37 years old. The first age and the third age are, similarly to FIG. 3, 35 years old and 45 years old, respectively.

In the embodiment, the first age and the second age are the same, and thus the learning processing is executed so that the first processing result and the second processing result become closer to each other. In the case of Modification Example 1, the first age and the second age are different, and thus learning processing different from that of the embodiment is executed. The learning module 204 executes the learning processing so that the difference between the first processing result and the third processing result is larger than the difference between the first processing result and the second processing result.

For example, the learning module 204 may execute the learning processing so that the difference between the first processing result and the second processing result becomes a difference corresponding to the difference between the first age and the second age. The learning module 204 executes the learning processing so that the difference between the first processing result and the third processing result becomes a difference corresponding to the difference between the first age and the third age. The difference between the first age and the third age is larger than the difference between the first age and the second age, and thus the difference corresponding to the difference between the first age and third age is larger than the difference corresponding to the difference between the first age and the second age.

As in Modification Example 1, when the first age to the third age are 35 years old, 37 years old, and 45 years old, respectively, the learning module 204 executes the learning processing so that the difference between the first processing result and the second processing result becomes a difference corresponding to 2 years, which is the difference between the first age and the second. The learning module 204 executes the learning processing so that the difference between the first processing result and the third processing result becomes a difference corresponding to 10 years, which is the difference between the first age and the third age. For example, the learning module 204 may calculate the triplet margin loss in the same manner as in the embodiment. However, the first age and the second age are not the same, and thus the margin α is smaller than in the embodiment.

The learning system 1 of Modification Example 1 executes the learning processing so that, when the difference between the first age and the third age is larger than the difference between the first age and the second age, the difference between the first processing result and the third processing result is larger than the difference between the first processing result and the second processing result. As a result, the learning processing can be executed by using the training data more effectively, and thus the accuracy of the learning model M is further improved. Further, the amount of training data to be prepared is less, and thus the burden on the creator of the learning model M is reduced.

### 5-2. Modification Example 2

For example, the triplet margin loss in the embodiment does not give direct consideration to the relationship between the second processing result and the third processing result, but the learning module 204 may execute the learning processing so that the difference between the second processing result and the third processing result becomes larger. In the example of FIG. 7, the learning module 204 may execute the learning processing based not only on the differences dp and dn, but also based on the difference between a second mean loss AA2 and a third mean loss AA3.

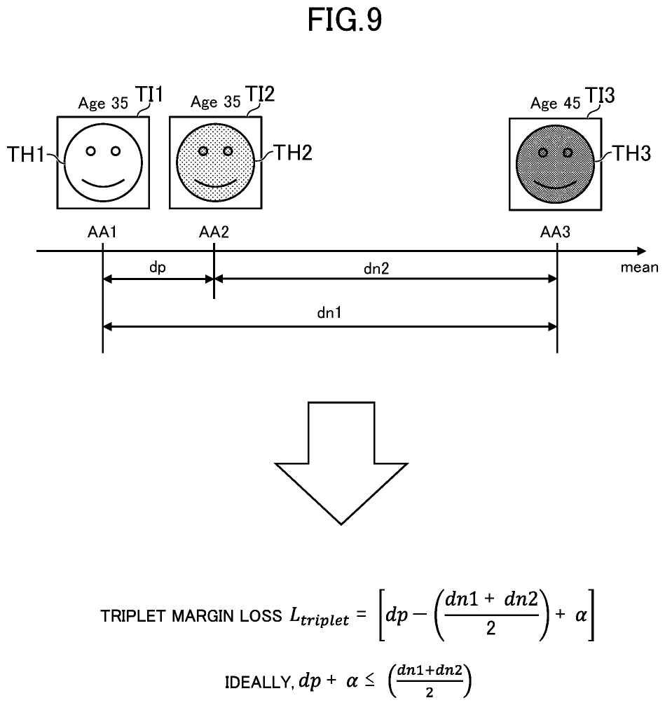

FIG. 9 is a diagram for illustrating an example of the triplet margin loss in Modification Example 2 of the present disclosure. In the example of FIG. 9, as in the embodiment, the first age is the same as the second age. For example, the learning module 204 calculates the average value of a difference dn1 between a first mean loss AA1 and the third mean loss AA3, and a difference dn2 between the second mean loss AA2 and the third mean loss AA3. The learning module 204 calculates the triplet margin loss by using the calculated average value instead of the difference dn described in the embodiment.

As illustrated in FIG. 9, the learning module 204 may calculate the triplet margin loss by substituting the difference dp between the first mean loss AA1 and the second mean loss AA2, the difference dn1 between the first mean loss AA1 and the third mean loss AA3, and the difference dn2 between the second mean loss AA2 and the third mean loss AA3 into another calculation expression other than the calculation expression used to calculate the average value. For example, the learning module 204 may calculate the triplet margin loss based on a value obtained by summing the difference between the differences dp and dn1 and the difference between the difference dp and the difference dn2.

Even when Modification Example 1 and Modification Example 2 are combined, the learning module 204 may calculate the triplet margin loss by using three differences. For example, the learning module 204 calculates the average value of the difference dn1 between the first mean loss AA1 and the third mean loss AA3, and the difference dn2 between the second mean loss AA2 and the third mean loss AA3. The learning module 204 may calculate the triplet margin loss by using the calculated average value instead of the difference dn described in the embodiment. In this case as well, the triplet margin loss may be calculated based on another calculation expression other than the calculation expression used to calculate the average value.

The learning system 1 of Modification Example 2 executes the learning processing so that the difference between the second processing result and the third processing result becomes larger. As a result, the learning processing can be executed by using the training data more effectively, and thus the accuracy of the learning model M is further improved. Further, the amount of training data to be prepared is less, and thus the burden on the creator of the learning model M is reduced.

### 5-3. Modification Example 3

For example, in Modification Example 2, the learning module 204 may execute the learning processing so that the difference between the second processing result and the third processing result becomes a difference corresponding to the difference between the second age and the third age. In the example of the embodiment, the difference between the second age and the third age is 10 years, and thus the learning module 204 executes the learning processing so that the difference between the second mean loss AA2 and the third mean loss AA3 becomes a difference of about 10 years. In the example of the Modification Example 1, the difference between the second age and the third age is 8 years, and thus the learning module 204 executes the learning processing so that the difference between the second mean loss AA2 and the third mean loss AA3 becomes a difference of about 8 years.

The learning system 1 of Modification Example 3 of the present disclosure executes the learning processing so that the difference between the second processing result and the third processing result becomes a difference corresponding to the difference between the second age and the third age. For example, the margin α in the triplet margin loss is determined so as to be a value corresponding to the difference between the second age and the third age. As a result, as compared to the related-art metric learning, in which the learning processing is executed so that images having different labels are simply moved further away from each other, the learning processing is executed so that the difference between a second processing result and a third processing result becomes a difference corresponding to an age difference, and thus the accuracy of the learning model M is further improved. That is, it is possible to perform optimal learning processing through use of the properties of the learning model M, such as estimating an estimated age, and thus the accuracy of the learning model M can be further improved.

### 5-4. Modification Example 4

For example, in the embodiment, there is described a case in which the learning processing is executed based on the triplet margin loss obtained by using the first estimation result, the second estimation result, and the third estimation result. The learning module 204 may execute the learning processing based on the first estimation result and the second estimation result without using the third estimation result.

For example, the learning module 204 calculates a Kullback-Leibler divergence based on the first distribution D1 and the second distribution D2. The Kullback-Leibler divergence is an index for evaluating the difference among a plurality of probability distributions D. Various calculation expressions can be used as the expression used to calculate the Kullback-Leibler divergence. The learning module 204 executes the learning processing based on the Kullback-Leibler divergence. As in the embodiment, when the first age is the same as the second age, the learning module 204 executes the learning processing so that the difference indicated by the Kullback-Leibler divergence becomes smaller. As in Modification Example 1, when the first age is different from the second age, the learning module 204 executes the learning processing so that the difference indicated by the Kullback-Leibler divergence becomes larger.

The learning module 204 may execute the learning processing based on the first estimation result and the second estimation result by using a method other than a method which uses the Kullback-Leibler divergence. For example, as in the embodiment, when the first age is the same as the second age, the learning module 204 may execute the learning processing so that the first average age AA1 and the second average age AA2 become closer. As in Modification Example 1, when the first age is different from the second age, the learning module 204 may execute the learning processing so that the first average age AA1 and the second average age AA2 move further away from each other.

The learning system 1 of Modification Example 4 of the present disclosure executes the learning processing based on the first estimation result and the second estimation result. As a result, the learning processing is completed through use of fewer estimation results, and thus the time required to complete learning can be reduced while increasing the accuracy of the learning model M. The learning device 20 does not execute a calculation for acquiring the third estimation result, and hence the processing load on the learning device 20 can be reduced.

Further, the learning system 1 calculates the Kullback-Leibler divergence based on the first distribution D1 and the second distribution D2, and executes the learning processing based on the Kullback-Leibler divergence. As a result, the learning processing can be executed by using a more reliable index, and thus the accuracy of the learning model M is further improved.

### 5-5. Modification Example 5

For example, in the embodiment, the learning module 204 executes the learning processing so that the total value of the softmax loss, the mean loss, and the variance loss, which correspond to the first loss, and the cosine similarity loss and the triplet margin loss, which correspond to the related loss, becomes smaller. The learning module 204 may execute the learning processing based on the first loss, a weighting coefficient relating to the related loss, and the related loss. In this case, the weighting coefficient may be set to be larger than 1 so that the related loss is given more importance than the first loss. The learning module 204 may calculate a final loss that gives consideration to the weighting coefficient, and execute the learning processing so that the final loss becomes smaller.

The learning system 1 of Modification Example 5 of the present disclosure executes the learning processing based on the first loss, the weighting coefficient relating to the related loss, and the related loss. As a result, for example, the related loss can be given more importance than the first loss, and thus the accuracy of the learning model M is improved. The learning processing may be executed through use of only the related loss, but because the first loss is still an important index, the learning processing can be executed while giving consideration to the first loss and the related loss in a well-balanced manner.

### 5-6. Modification Example 6

For example, in the embodiment, the cosine similarity loss and the triplet margin loss are described as examples of related losses. The Kullback-Leibler divergence described in Modification Example 4 also indicates a relationship among a plurality of processing results, and hence is also an example of a related loss. As described in the embodiment and Modification Example 4, the learning module 204 may calculate a plurality of related losses based on the first processing result and the second processing result. The learning module 204 executes the learning processing based on the first loss and the plurality of related losses. Other losses may be used as a related loss. The learning module 204 calculates a total loss based on the first loss and the plurality of related losses, and executes the learning processing based on the total loss.

The learning system 1 of Modification Example 6 of the present disclosure executes the learning processing based on the first loss and the plurality of related losses. As a result, the learning processing can be executed by giving consideration to a larger number of related losses, and thus the accuracy of the learning model M is further improved.

### 5-7. Other Modification Examples

For example, the modification examples described above may be combined.

For example, the first age is different from the second age and the third age, but the second age and the third age may be the same. In this case, the learning module 204 may execute the learning processing so that the difference between the first processing result and the second processing result becomes larger and the difference between the first processing result and the third processing result becomes larger. Further, the first age, the second age, and the third age may all be the same. In this case, the learning module 204 may execute the learning processing so that the difference between the first processing result and the second processing result becomes smaller and the difference between the first processing result and the third processing result becomes smaller.

Further, for example, the functions described as being implemented by the learning device 20 may be implemented by another computer, or may be shared by a plurality of computers. The data described as being stored on the learning device 20 may be stored on another computer or information storage medium.

The invention claimed is:

1. A learning system, comprising at least one processor configured to:
acquire a first training image relating to a first object having a first numerical value;
acquire a second training image relating to a second object having a second numerical value; and
execute learning processing of a learning model which estimates a numerical value to be estimated relating to an object to be estimated included in an estimation-target image, based on metric learning using the first training image and the second training image.

2. The learning system according to claim 1, wherein the at least one processor configured to:
acquire a third training image relating to a third object having a third numerical value, and
execute the learning processing based on the metric learning using the first training image, the second training image, and the third training image.

3. The learning system according to claim 2,
wherein the first numerical value is the same as the second numerical value,
wherein the first numerical value is different from the third numerical value, and
wherein the at least one processor is configured to:
acquire a first processing result obtained by the learning model based on the first training image;
acquire a second processing result obtained by the learning model based on the second training image;
acquire a third processing result obtained by the learning model based on the third training image; and
execute the learning processing so that a difference between the first processing result and the second processing result becomes smaller and a difference between the first processing result and the third processing result becomes larger.

4. The learning system according to claim 2,
wherein the first numerical value is different from both the second numerical value and the third numerical value,
wherein a difference between the first numerical value and the third numerical value is larger than a difference between the first numerical value and the second numerical value, and
wherein the at least one processor is configured to:
acquire a first processing result obtained by the learning model based on the first training image;
acquire a second processing result obtained by the learning model based on the second training image;
acquire a third processing result obtained by the learning model based on the third training image; and
execute the learning processing so that a difference between the first processing result and the third processing result becomes larger than a difference between the first processing result and the second processing result.

5. The learning system according to claim 3, wherein the at least one processor is configured to execute the learning processing so that the difference between the first processing result and the third processing result becomes a difference corresponding to a difference between the first numerical value and the third numerical value.

6. The learning system according to claim 3,
wherein the first processing result is a first estimation result obtained by the learning model,
wherein the second processing result is a second estimation result obtained by the learning model,
wherein the third processing result is a third estimation result obtained by the learning model, and
wherein the at least one processor is configured to execute the learning processing based on the first estimation result, the second estimation result, and the third estimation result.

7. The learning system according to claim 6,
wherein the first estimation result is a first distribution including each of a plurality of numerical values and a first probability that the first object has the each of the plurality of numerical values,
wherein the second estimation result is a second distribution including each of the plurality of numerical values and a second probability that the second object has the each of the plurality of numerical values,
wherein the third estimation result is a third distribution including each of the plurality of numerical values and a third probability that the third object has the each of the plurality of numerical values, and
wherein the at least one processor is configured to execute the learning processing based on the first distribution, the second distribution, and the third distribution.

8. The learning system according to claim 3, wherein the at least one processor is configured to execute the learning processing so that a difference between the second processing result and the third processing result becomes larger.

9. The learning system according to claim 8, wherein the at least one processor is configured to execute the learning processing so that the difference between the second processing result and the third processing result becomes a difference corresponding to a difference between the second numerical value and the third numerical value.

10. The learning system according to claim 1, wherein the at least one processor is configured to:
calculate a first feature amount relating to the first training image based on the first training image and the learning model;
calculate a second feature amount relating to the second training image based on the second training image and the learning model; and
execute the learning processing based on the first feature amount and the second feature amount.

11. The learning system according to claim 10, wherein the at least one processor is configured to:
calculate a cosine similarity based on the first feature amount and the second feature amount; and
execute the learning processing based on the cosine similarity.

12. The learning system according to claim 1, wherein the at least one processor is configured to:
acquire a first estimation result obtained by the learning model based on the first training image;
acquire a second estimation result obtained by the learning model based on the second training image; and
execute the learning processing based on the first estimation result and the second estimation result.

13. The learning system according to claim 12,
wherein the first estimation result is a first distribution including each of a plurality of numerical values and a first probability that the first object has the each of the plurality of numerical values,
wherein the second estimation result is a second distribution including each of the plurality of numerical values and a second probability that the second object has the each of the plurality of numerical values, and
wherein the at least one processor is configured to:
calculate a Kullback-Leibler divergence based on the first distribution and the second distribution; and
execute the learning processing based on the Kullback-Leibler divergence.

14. The learning system according to claim 1, wherein the at least one processor is configured to:
acquire a first estimation result obtained by the learning model based on the first training image;
calculate a first loss based on the first estimation result and the first numerical value;
calculate a related loss based on a relationship between a first processing result of the learning model based on the first training image and a second processing result of the learning model based on the second training image; and
execute the learning processing based on the first loss and the related loss.

15. The learning system according to claim 14, wherein the at least one processor is configured to execute the learning processing based on the first loss, a weighting coefficient relating to the related loss, and the related loss.

16. The learning system according to claim 14, wherein the at least one processor is configured to:
calculate a plurality of first losses each of which is the first loss based on the first estimation result and the first numerical value; and
execute the learning processing based on the plurality of first losses and the related loss.

17. The learning system according to claim 14, wherein the at least one processor is configured to:
calculate a plurality of related losses each of which is the related loss based on the first processing result and the second processing result; and
execute the learning processing based on the first loss and the plurality of related losses.

18. The learning system according to claim 1,
wherein the first object and the second object are humans different from each other,
wherein the first numerical value is an age of the first object,
wherein the second numerical value is an age of the second object,
wherein the object to be estimated is a human for which his or her age is to be estimated, and
wherein the numerical value to be estimated is the age of the object to be estimated.

19. A learning method, comprising:
acquiring a first training image relating to a first object having a first numerical value;
acquiring a second training image relating to a second object having a second numerical value; and
executing learning processing of a learning model which estimates a numerical value to be estimated relating to an object to be estimated included in an estimation-target image, based on metric learning using the first training image and the second training image.

20. A non-transitory computer-readable information storage medium for storing a program for causing a computer to:
acquire a first training image relating to a first object having a first numerical value;
acquire a second training image relating to a second object having a second numerical value; and
execute learning processing of a learning model which estimates a numerical value to be estimated relating to an object to be estimated included in an estimation-target image, based on metric learning using the first training image and the second training image.
